(19) United States
(12) Patent Application Publication
(10) Pub. No.: US 2010/0297337 A1
(43) Pub. Date: Nov. 25, 2010

(54) PROCESS FOR THE PREPARATION OF COATINGS EXHIBITING INCREASED CONDUCTIVITY BASED ON POLYTHIOPHENE AND ITS DERIVATIVES

(75) Inventor: Bernhard Wessling, Bargteheide (DE)

Correspondence Address: SENNIGER POWERS LLP, 100 NORTH BROADWAY, 17TH FLOOR, ST LOUIS, MO, 63102, US

(73) Assignee: ORMECON GMBH, Ammersbek (DE)

(21) Appl. No.: 12/811,545

(22) PCT Filed: Dec. 12, 2008
(86) PCT No.: PCT/EP08/10934

§ 371 Date: Jul. 2, 2010

(30) Foreign Application Priority Data
Jan. 4, 2008 (DE) 10 2008 003 251.4
Nov. 27, 2008 (DE) 10 2008 059 389.3

(51) Int. Cl. B05D 5/06; H01B 1/12; B05D 5/12

(52) U.S. Cl. 427/64; 252/500; 427/79; 427/108

(57) ABSTRACT

The present invention relates to a process for the preparation of a coating displaying increased conductivity which contains at least one conductive polymer derived from optionally substituted thiophene, optionally together with at least one further conductive polymer, in particular polyaniline, in which process firstly an aqueous or organic dispersion or solution which contains the at least one conductive polymer is applied to a substrate; thereafter the forming or formed layer is dried; and at least one polar solvent is brought into contact with the formed or forming layer during or after the drying. The invention also relates to the preparation of an article in which a coating according to the present invention is applied to the surface of a transparent substrate. Furthermore, the present invention relates to the use of a polar solvent for increasing the conductivity of a coating containing at least one conductive polymer derived from optionally substituted thiophene.

The present invention relates to a process for the preparation of coatings exhibiting increased conductivity which contain polythiophene and its optionally substituted derivatives, optionally together with further conductive polymers.

### STATE OF THE ART

It is known to increase the conductivity of polythiophenes by adding polar solvents. Thus e.g. B. F. Louwet et al. describe in Synth. Met. 2003 135-136, 115 increasing the conductivity of PEDT/PSSH (PEDT=polyethylene dioxythiophene; PSSH=polystyrene sulphonic acid or its anion, also called “PSS” in abbreviated form) by adding NMP. In the literature, the addition of NMP (=N-methylpyrrolidone), DMSO (=dimethyl sulphoxide) or diethylene glycol is preferentially described, wherein the corresponding solvents of the aqueous dispersion or solution of the PEDT-PSSH are added, in most cases in the range up to 10%, before coatings are then formed from the dispersions/solutions which then contain corresponding quantities of the solvents.

J. Ouyang et al. describe in Polymer 2004, 45, 8443 the results of their investigations into the causes of the increase in conductivity. In the Journal of Polymer Science: Part B: Polymer Physics, Vol. 41, 2561-2583 (2003) X. Crispin et al. give in their review a comprehensive overview of properties of conductive polymers based on polythiophenes or thiophene derivatives, with the emphasis on PEDT-PSSH, and report in a corresponding section on the results of the investigations into the causes of the increase in conductivity when polar solvents are added. They ascribe the phenomenon to the phenomena described by MacDiamid and Epstein in Synth. Met. (Special Issue) Vol. 65, Nos. 2-3, August 1994, pp. 103-116 for polyaniline and called “secondary doping”. MacDiamid and Epstein are cited in this publication with the following disclosure: “In phenomenological terms a secondary doping agent is a seemingly “inert” substance which induces a further increase in the conductivity of a primarily doped conjugated polymer. It differs from a primary doping agent in that the improved properties remain even after the complete removal of the secondary doping agent.” J. Ouyang et al. further disclose:

“Chemically prepared PEDT/PSS displays a significant increase in conductivity from 0.8 to 80 S/cm when inert solvents are added. According to the definition given above this effect can be classified as secondary doping, although the mechanism seems to differ from that for polyaniline. The temperature dependence of the resistance shows that the PEDT/PSS system is close to the critical range (insulator-metal transition) if organic solvents (dimethyl sulphoxide (DMSO), N,N-dimethylformamide (DMF) and tetrahydrofuran (THF) are used. On the basis of these new data we suggest an explanation for the secondary doping of PEDT/PSS with DEG. In the emulsion, the solvent DEG is present both in water and in the PEDT/PSS-particles. A weight ratio of 0.5 for DEG to PEDT/PSS represents a limit for the quantity of DEG needed in the PEDT/PSS particles to have a separation between the excess insulating PSS and the conductive PEDT/PSS. This phase separation is possible because DEG takes up PEDT/PSS after evaporation of water due to weakening of the electrostatic bonds.”

In all these cases the polar solvent such as e.g. DMSO and others is added to the aqueous dispersion (or often also called solution) before the layer is formed. The polar solvents thus seem to bring about a change in the morphology, which Crispin et al. also describe in Chem. Mater. 2006, 18, 4354-4360. They explain the increase in the conductivity of PEDT/PSSH dispersions by 3 orders of magnitude due to the addition of diethylene glycol by the formation of a 3-dimensional network which the PEDT/PSSH dispersion forms when diethylene glycol is added. In this connection it is interesting to note that aqueous polyaniline dispersions which contain PSSH as counterion do not react to the addition of the corresponding polar solvents with an increase in conductivity. Rather, this phenomenon is limited to polyaniline with the counterion camphorsulphonic acid and the addition of phenols.

There is also a corresponding procedure in the patent literature, and there is a series of patents in which special versions of the addition of different polar solvents to aqueous polythiophene dispersions are described, e.g. U.S. Pat. No. 6,692,662 B2 discloses according to claim 1 a composition comprising a combination of an aqueous dispersion of an optionally substituted poly-3,4-alkylenedioxythiophenate ion and an associated polyanion and 1% (weight/volume) to 100% (weight/volume) of at least one of dimethylacetamide (DMAC), N-methylpyrrolidone (NMP), ethylene glycol or mixtures thereof, wherein at least 30% (weight/volume) of the water of the aqueous dispersion is removed from the combination.

WO-A-02/072660 discloses in particular in claim 1 a process for the preparation of dispersions or solutions which contain optionally substituted polythiophenes in organic solvents which is characterized in that
a) an organic solvent miscible with water or a solvent mixture miscible with water is added to an aqueous dispersion or solution containing optionally substituted polythiophenes and
b) the water is at least partly removed from the resulting mixture.

WO-A-2004/021366 discloses in claim 1 a mixture comprising:
a) a dispersion consisting substantially of an oligomer, dendrimer or polymer containing thiophene groups in a cationic form with an anionic compound, an anionic oligomer, an anionic dendrimer or an anionic polymer and water, and
b) at least one additive that contains one or more species of the following functional groups: ketal, lactone, carbonate, cyclic oxide, diketone, anhydride, aminocarbonic acid, phenol and inorganic acid, and one or more species of the derivatives of these functional groups.

The aqueous formulations, containing different polythiophene derivatives, described in the state of the art have achieved a certain limited importance in the market, but still suffer from various disadvantages, among which are the following:
The added quantity of such polar organic solvents is relatively high, at several percent.
Higher conductivity values (after drying of the applied layers) in the range of 500 S/cm can be achieved only with special dispersions such as e.g. Baytron PH500 (manufacturer: H. C. Starck), while standard products from this company such as Baytron P HCV4 achieve only roughly 200 S/cm for the same quantity of DMSO. Only values below 1 S/cm can be achieved with EL 4083 despite the same addition of polar organic solvents.
Dispersions which, in addition to PEDT, contain other conductive polymers such as polyaniline display a clearly smaller increase in conductivity, as polyaniline-PSSH does not react through polar solvents such as DMSO, NMP and the like to the addition of these solvents with an increase in conductivity.
If the aqueous dispersions which contain PEDT (or optionally substituted polythiophene derivatives) alone or together with other polymers, such as e.g. polyaniline, are converted into organic solutions through replacement of the water with organic solvents, the addition of the polar solvent additives (DMS, NMP, DEG and others) brings about a very much smaller increase in conductivity, hitherto up to at most 100 S/cm.

### Object

The object forming the basis of the present invention was thus to overcome the above disadvantages and provide a generally applicable process for increasing the conductivity of layers (coatings) by means of polar solvents (“secondary doping”) which contain conductive polymers based on optionally substituted thiophenes (e.g. PEDT), wherein the layers should be able to be formed from dispersions that are aqueous or predominantly based on organic media (e.g. containing less than 1% water).

### SUMMARY OF THE PRESENT INVENTION

Surprisingly, the above object was solved by a process for the preparation of a coating displaying an increased conductivity wherein at least one polar solvent as defined herein is not added to the dispersion which contains the constituents of the coating to be produced. Instead, according to the invention, the at least one polar solvent is contacted with the coating after the actual coating step, i.e. after deposition of the coating, i.e. after or during drying of the coating formed.

According to another aspect, the present invention relates to a process for the preparation of a coating displaying an increased conductivity, wherein the coating contains a first conductive polymer and at least one further conductive polymer, wherein the first conductive polymer is derived from optionally substituted thiophene, in which process
a) firstly an aqueous or organic dispersion or solution which contains the conductive polymers is prepared by
   i. polymerizing the monomer from which the first conductive polymer is derived in a dispersion or solution of the at least one further polymer, or
   ii. polymerizing the monomer from which the at least one further conductive polymer is derived in a dispersion or solution of the first polymer, or
   iii. simultaneously polymerizing the monomers from which the conductive polymers are derived in a dispersion or solution,
b) the aqueous or organic dispersion or solution which contains the conductive polymers is then applied to a substrate, and
c) the forming or formed layer is then dried and
d) at least one polar solvent is brought into contact with the forming or formed layer after the drying.

The present invention also relates to a process for the preparation of an aqueous or organic dispersion or solution which contains a first conductive polymer and at least one further conductive polymer, wherein the first conductive polymer is derived from optionally substituted thiophene, in which process
i. the monomer from which the first conductive polymer is derived is polymerized in a dispersion or solution of the at least one further polymer, or
ii. the monomer from which the at least one further conductive polymer is derived is polymerized in a dispersion or solution of the first polymer, or
iii. the monomers from which the conductive polymers are derived are simultaneously polymerized in a dispersion or solution.

Finally the present invention relates to a process for the preparation of an article selected from the group consisting of transparent substrates, flexible or rigid conductive sub-strates such as films (based on e.g. polymethylmethacrylate, polycarbonate, polyethyleneterephtalate etc.), in particular films for touch panels, digital paper, organic LEDs (OLEDs), electroluminescence displays, rechargeable batteries, capacitors, supercapacitors, light-emitting diodes, sensors, electrochrome disks, copier drums, cathode ray tubes, antistatic or electromagnetically screening plastic films and moulded parts and photographic materials, in which a coating prepared according to the invention is used, i.e. in which one or more areas or parts of the article is or are provided with a coating according to the invention.

Further preferred versions of the present invention are disclosed in the appended dependent claims.

The terms “layer” and “coating” are used synonymously herein.

### DETAILED DESCRIPTION OF THE INVENTION

The invention can be carried out in different ways, the decisive factor being that the at least one polar solvent is not added to the (aqueous or organic) dispersion which contains the constituents of the layer to be produced. Instead, according to the invention the at least one polar solvent can be brought into contact with the further forming layer, i.e. the as a rule still drying layer, or with the already fully-formed layer, i.e. the as a rule completely dried layer, separately after the actual coating, i.e. after the substrate to be coated is no longer in direct contact with the reservoir of the dispersion/solution. The dispersion/solution is further prepared as described herein.

The bringing into contact with the at least one polar solvent can in particular take place by the polar solvent(s) of the coating being supplied either from the vapour phase, as a spray mist or as an additional thin coating (for example by spin coating).

Surprisingly, the conductivity values achieved using comparatively smaller quantities of polar solvent (relative to the quantity of same incorporated into the layer) are at least comparable with those which are achieved when the corresponding solvents are added in quantities of several percent to the starting dispersion before the layer forms.

In some cases, however, clearly better values can be achieved:
Approx. 500 S/cm can be achieved not only with Baytron P H500, but also with HCV4, which is not possible when adding the polar additives to the dispersion of HCV4.
Layers which have been precipitated from dispersions which, in addition to PEDT, contain e.g. polyaniline as a further conductive polymer may also display a conductivity around 500 S/cm if the polar additive is allowed to act during or after formation/drying of the layer, while the comparable dispersions, if they contain the polar solvent before the layer formation, lead to layers with only approx. 200 S/cm. This is particularly surprising, as these dispersions also contain polyaniline, overall therefore less PEDT that can react positively to the polar solvents with an increase in conductivity, while the conductivity of polyaniline alone cannot be increased by adding e.g. DMSO or NMP.
Conversely, it is surprisingly observed according to the invention that layers which have been precipitated from dispersions which, in addition to PEDT, contain e.g. polyaniline as further conductive polymer may also display a conductivity around and above 500 S/cm if chlorophenol is used as polar additive and allowed to act during or after formation/drying of the layer, while the comparable dispersions, if they contain the polar solvent before the layer formation, lead to layers with only approx. 200 S/cm. This is particularly surprising, as chlorophenol does not increase conductivity when applying the processes of the state of the art in the case of dispersions which contain PEDT, but only in the case of polyaniline. In other words, although less polyaniline sensitive to chlorophenol is present when using a combination of PEDT and polyaniline, a significant increase in conductivity is achieved.
If dispersions containing aqueous PEDT and, as further conductive polymer, e.g. polyaniline are converted into organic dispersions e.g. in accordance with the teaching of EP 1 849 815 A1, a conductivity of at most 50-100 S/cm was previously possible by means of the addition of polar solvents. However, when applying the procedure according to the invention conductivity values of over 200-300 S/cm are surprisingly possible.

In the case of the optionally substituted thiophene polymers according to the invention, one is preferably used which has repeat units of the following formula

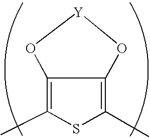

in which Y represents —(CH₂)ₙ—CR¹R²(CH₂)ₙ— or an optionally substituted 1,2-C₃ to C₈ cycloalkylene residue and

R¹ and R² independently of each other represent hydrogen, hydroxymethyl, an optionally substituted C₁ to C₂₀ alkyl residue or an optionally substituted C₆ to C₁₄ aryl residue,

and
m, n are the same or different and are an integer from 0 to 3.

The layer according to the invention preferably contains polythiophene (PTh), poly(3,4-ethylene dioxythiophene) (PEDT) and/or polythienothiophene (PTT), in particular PEDT.

The dispersion/solution from which the layers according to the invention is deposited thus contains a conductive polymer based on optionally substituted thiophene, as defined above, alone or, preferably, together with at least one other conductive polymer, as explained in more detail below. This can take place in the form of chemical compounds, such as e.g. copolymers or graft copolymers, or physical mixtures. Mixtures of two or more different polymers derived from optionally substituted thiophene can also be used.

With regard to the thiophene-based polymer according to the invention or the further conductive polymers which can be incorporated into the layer according to the invention, the following applies: described as conductive polymers, which are also called “intrinsically conductive polymers” or “organic metals”, are substances which are derived from low-molecular compounds (monomers), are at least oligomeric through polymerisation, i.e. contain at least 3 monomer units which are linked by chemical bonding, display a conjugated n-electrons system in the neutral (non-conductive) state and can be converted by oxidation, reduction or protonation (often called “doping”) into an ionic form which is conductive. The conductivity is at least 10⁻⁷ S/cm.

Most conductive polymers display a more or less marked increase in conductivity as the temperature rises, which shows them to be non-metallic conductors. A few representatives of this class of substances display a metallic behaviour, at least in a temperature range close to room temperature, inasmuch as conductivity falls as temperature rises. A further method of recognizing metallic behaviour is to plot the so-called “reduced activation energy” of the conductivity against the temperature at low temperatures (down to nearly 0 K). Conductors with a metallic contribution to conductivity display a positive slope of the curve at low temperature. Such substances are called “organic metals”.

The term “conductive polymer” as used in the present case covers both intrinsically conductive polymers and the so-called organic metals, as discussed above.

Examples of the intrinsically conductive polymers or organic metals according to the invention which, in addition to polythiophene or its derivatives, are constituents of the layers according to the invention are in particular polyaniline (PAni), polydiacetylene, polyacetylene (PAc), polypyrrole (PPy), polyisothianaphthene (PITN), polyheteroarylene vinylene (PArV), wherein the heteroarylene group can be e.g. thiophene, furan or pyrrole, poly-p-phenylene (PpP), polyphenylene sulphide (PPS), polyperinaphthalene (PPN), polyphthalocyanine (PPc) and others, and their derivatives (which are formed e.g. from monomers substituted with side chains or groups), their copolymers and their physical mixtures. Polyaniline (PAni) and its derivatives are particularly preferred. Polyaniline is most preferred.

Preferred binary mixtures are those comprised of PAni and PTh, PAni and PEDT, PEDT and PPy and also PEDT and PTh.

The layers can also contain further additives, wetting aids, antioxidants, lubricants and optionally non-conductive polymers. In particular a thermoplastic polymer can be used. For example polyethylene terephthalate copolymer, commercially available from Eastman Kodak, or a polymethyl methacrylate (PMMA) from Degussa can be used.

There are numerous ways for preparing the dispersions for forming the coatings which are to be contacted with the polar solvents of the present invention.

For example, commercially available PEDT dispersion such as Baytron P HCV4 or PH 500 may be used, or EDT or other optionally substituted thiophene monomers may be polymerized in accordance with methods known in the art and the resulting products be dispersed in water. Chemical or physical mixtures of the optionally substituted thiophene polymers with other conductive polymers such as optionally substituted polyaniline may also be used.

According to a preferred aspect of the invention, to prepare the dispersions/solutions from which the layers according to the invention can then be deposited, monomers are polymerized which lead to the conductive polymers described above. The polymerization procedure is e.g. as described above, i.e. according to alternatives (i) to (iii). Optionally polymerization takes place in the presence of suitable doping acids.

Dispersions which are prepared by polymerizing EDT (ethylene dioxythiophene) in an aqueous dispersion of polyaniline (e.g. ORMECON® D 1012 or D 1022 W from Ormecon GmbH) or by polymerizing aniline in an aqueous PEDT dispersion (e.g. in Baytron PH500) are preferred and particularly suitable for carrying out the invention. A simultaneous polymerization of EDT and aniline in the presence of the doping acid is also possible.

The ratio of the first conductive polymer, in particular PEDT (or optionally substituted thiophene polymer) to the at least one further conductive polymer, if present, in particular polyaniline, can be freely chosen and is determined according to transparency requirements, the ratio of the optionally substituted thiophene polymer to polyaniline lying preferably between 1:10 and 10:1, preferably 1:1 to 8:1, such as about 2:1, in each case relative to mols of monomer units.

It is known to a person skilled in the art that such dispersions of conductive polymers, depending on the degree of oxidation and protonation of the respective polymer, contain anions suitable for charge equalization of e.g. poly acids such as PSSH or other sulfonic acids such as methanesulfonic acid. The latter are not always expressly mentioned in the present description.

Copolymers or graft copolymers from the monomers which form the basis of the above-named polymers are also suitable.

An optionally desired conversion of the aqueous dispersions which in particular contain PEDT, optionally in combination with other conductive polymers, into organic solvent systems can take place by known methods, e.g. according to the process described by Nissan Chemicals Industries in EP 1 849 815 A1. The procedure according to the invention is that in step a) an aqueous dispersion is prepared which before step b) is first converted into a dispersion based on at least one organic dispersant with a water content of less than 1%, relative to the weight of the whole dispersion. Suitable organic solvents are for example primary or secondary monohydric or polyhydric alcohols, in particular those with 1 to 4 C atoms, such as methanol, ethanol, propanol, 2-propanol, propanediol etc.

It is essential that the layers according to the invention containing (optionally substituted) thiophene polymers which may contain further conductive polymers such as e.g. (optionally substituted) polyaniline are brought into contact during or after the drying of the layer with the polar solvents according to the invention.

Organic solvents with a dielectric constant (DE) of >25 are preferably considered as polar solvents which increase the conductivity of the layers. Solvents with a DE of 30 to 55 are preferred.

In particular the polar solvents according to the invention have a boiling point above 100° C. at normal pressure.

The solvents according to the invention are preferably selected from the group consisting of aliphatic, cycloaliphatic, aromatic, heterocyclic (saturated and unsaturated) and heteroaromatic solvents and also substituted derivatives thereof with a total of 1 to 10 C atoms, in particular 1 to 6 C atoms. For example the solvents according to the invention are selected from the group consisting of formic and acetic acid derivatives such as formamides and acetamides, in particular formamides and acetamides which display single or double methyl substitution at the nitrogen of the amide group and also sulphoxides. There may be further mentioned as preferred aromatic solvents nitrogen-substituted benzene derivatives, in particular benzene derivatives substituted with a nitro group such as nitrobenzene. According to the invention nitrogen-containing mononuclear heterocycles are also suitable, for example N-methylpyrrolidone. Halogen-substituted phenols such as chlorophenol can also be used and are preferred according to the invention. Furans, in particular tetrahydrofuran, are also suitable.

Solvents that are suitable according to the invention are preferably amidic solvents based on formic and acetic acid such as in particular formamide, N-methylacetamide, N,N-dimethylacetamide, N-methylpyrrolidone, N-methylcaprolactam and N-methylformamide.

Alcohols and ethers such as ethylene glycol, glycerol, ethylene glycol dimethylether, ethylene glycol monomethylether, ethylene glycol monobutylether or dioxan are also suitable according to the invention. Sulphur-containing organic solvents such as dimethyl sulphoxide are also suitable and preferred according to the invention.

In particular, DMSO, NMP, diethylene glycol, DMA (=dimethylacetamide), DMF and/or nitrobenzene are preferred. DMSO is particularly preferred.

Furthermore, organic acids may be used as the polar solvent of the present invention. For example, acids meeting the above criteria for the dielectric constant and boiling point may be used. In particular, sulfonic acid derivatives such as substituted or unsubstituted C₁ to O₃ methanesulfonic acid derivatives may be used, in particular halogen substituted, more preferably fluorine substituted acids. Particularly preferred is trifluoromethanesulfonic acid.

After the bringing into contact and drying of the coatings according to the invention the obtained layer thicknesses were about 50 to 80 nm. Compared with the layer thicknesses immediately after the preparation of the coatings, i.e. before bringing into contact with the solvent according to the invention, they had surprisingly reduced by roughly 25% to 70%.

The conductivity of the coatings prepared and treated in accordance with the present invention is preferably higher than 100 S/cm, in particular higher than 30.0 S/cm or higher than 350 S/cm, and can e.g. be in the range of from 100 or 300 or 350 to 3000 S/cm. The conductivity is measured in accordance with the four-point probe method of van der Pauw.

The coatings prepared according to the invention can be used in general for transparent substrates, inter alia for flexible or rigid conductive substrates such as films, e.g. for touch panels, for “digital paper”, organic LEDs (OLEDs), electroluminescence displays, or in the manufacture of rechargeable batteries, capacitors, supercapacitors, light-emitting diodes, sensors, electrochrome disks, as coatings on copier drums, cathode ray tubes, as antistatic or electromagnetic screening finishes for plastic films and moulded parts or on photographic materials.

The following examples are intended to explain the procedure according to the invention by way of example compared with the results which can be achieved according to the state of the art, and without limiting the scope of the invention. The conductivity was determined by means of four-point measurement, and the layer thicknesses determined using a Dektak Profilometer.

### Example 1

### Comparison

The dispersions ORMECON D 1031 W, D 1032 W and D 1033 W (which contain PEDT and polyaniline) commercially available from Ormecon GmbH were reacted with 5% DMSO in each case compared with the dispersions Baytron P HCV4 and Baytron P HS00 commercially available from H.C. Starck and processed into a thin layer by spin coating on glass and then dried (10 min at 120° C.). The layer thicknesses were between 50 and 100 nm.

In accordance with the instructions of EP 1 849 815 A1, D 1033 W was converted into methanol or ethanol, DMSO was added to the dispersion and the mixture likewise processed into a thin layer and dried. The layer thicknesses were between 50 and 100 nm.

The following results were obtained:

| | | S/cm | | |
|---|---|---|---|---|
| | S/cm | after | S/cm after | |
| | without | (%) DMSO | (%) NMP | S/cm after (%) |
| Dispersion | addition | addition | addition | other addition |
| D 1031 W | | | 30 | |
| | | | (5% NMP) | |
| D 1032 W | 6 | 150 | 150 | |
| | | (5% DMSO) | (6% NMP) | |
| D 1033 W | 0.5 | 200 | 150 | |
| | | (8% DMSO) | (8% NMP) | |
| from D1032 | 0.1 | 60 | | |
| in MeOH | | | | |
| from D | 1 | 40 | | |
| 1032 | | | | |
| in EtOH | | | | |
| from D | 0.1 | | | |
| 1033 | | | | |
| in MeOH | | | | |
| ET-574 | 1 | 290 | 340 | |
| Baytron P | 10 | 300 | 300 | 300 (5% EG) |
| HCV4 | | (5% DMSO) | (5% NMP) | 300 (5% 1,4- |
| | | | | butanediol) |
| | | | | 60 (5% |
| | | | | propylene |
| | | | | carbonate) |
| >Baytron | 0.3 | 400 | 350 | |
| PH500 | | (8% DMSO) | (8% NMP) | |

EG = Ethylene glycol

The addition of these or other polar solvents to dispersions which do not contain PEDT, but only polyaniline, e.g. to ORMECON D 1012 or D 1021 W (conductivity 0.1 S/cm), did not lead to an increase in conductivity.

Dispersion ET 574 is a dispersion which was prepared by polymerization of aniline in Baytron P HCV4 and has a PEDT-to-aniline ratio of 2:1 (relative to mols monomer units).

### Example 2

### According to the Invention

Firstly, dispersions were prepared as described in Example 1, but without the addition of DMSO to the respective dispersion. Proceeding in accordance with the invention, the dispersion was then applied to the substrate, and only then was DMSO or another suitable solvent with a dielectric constant >25 brought into contact with the forming layer, i.e. during the drying, or with the fully formed layer, i.e. after the substantially complete drying. This was carried out as follows:

a) During the drying:

The substrate was coated with the dispersion (for example by means of spin coating), and then placed, in a box which has an opening to an outlet, on a heating plate which was set at 50° C. There was an open vessel with DMSO on the same heating plate, with the result that the layer was exposed to a gas atmosphere which had a partial pressure of DMSO corresponding to this temperature. After 24 hours the sample was removed and the conductivity determined.

b) After the drying:

Firstly, the dispersion applied to the substrate was dried (e.g. 10 min at 120° C.). The coated substrate was then kept in a sealed vessel, e.g. a glass flask, for 1 hour in the gas space above the level of the liquid of the DMSO or other polar solvents, while the respective solvent was heated e.g. to 100° C.

c) By means of spin coating:

The layer dried according to b) on the substrate was brought into contact with DMSO (or another solvent) in a spin coater, the excess DMSO/solvent was removed by spinning and then drying was carried out (10 min at 120° C.).

The layer thicknesses obtained were about 50 to 100 nm. Compared with the layer thicknesses immediately after the preparation of the coating, i.e. before the addition of the solvent according to the invention, they had reduced by about 25% to 70%. The layer thicknesses were measured with a Dektak profilometer.

The following conductivity values resulted:

| | DMSO in the | DMSO in the | DMSO applied by |
|---|---|---|---|
| | gas space | gas space | means of |
| | during the | after the | spin coating, |
| Dispersion | drying | drying | then dried |
| D 1031 W | | 40 | 100 |
| D 1032 W | 200 | 220 | 330 |
| D 1033 W | 250 | 260 | 300 |
| from D1032 | | 200 | 240 |
| in MeOH | | | |
| from D 1032 | 100 | 180 | 200 |
| in EtOH | | | |
| from D 1033 | | 250 | 350 |
| in MeOH | | | |
| ET-574 | 440 | 500 | 500 |
| Baytron P | 300 | 300 | 570 |
| HCV4 | | | |
| Baytron | 420 | 400 | 570 |
| PH500 | | | |

The bringing into contact of layers that had been formed from dispersions that did not contain PEDT, but only polyaniline, e.g. from ORMECON D 1012 or D 1021 W (conductivity 0.1 S/cm), with DMSO or other polar solvents during or after the drying or by means of spin coating did not lead to an increase in conductivity.

### Example 3

### According to the Invention

Various polar solvents were used according to the procedure as described in Example 2, variant a), during the drying of layers that had been formed from the dispersions named below. The following results were obtained (the conductivity is given in S/cm in each case):

### Baytron P HCV 4

NMP: 425
2-Br-propionic acid: 505

### ORMECON D 1032 W

NMP: 330
Glycerol: 495
Ethylene glycol: 425
Formamide: 415
2-Br-propionic acid: 385

### ORMECON D 1033 W

NMP: 360
Ethylene glycol: 455
di-Cl-acetic acid: 360
Chlorophenol: 685
2-Br-propionic acid: 500-900

### Example 4

814 g PEDT-PSSH dispersion (Clevios PHCV4) and 370 μL aniline were placed in a 1 L reaction vessel equipped with a cooling jacket and a stirrer. The batch was stirred and cooled for 15 min at a temperature of the cooling liquid of 0° C. A solution of 925 mg ammonium peroxodisulphate in 89.5 mL water was added to the batch in four portions, each separated by a time interval of 15 min, wherein each of the first three portions had a volume of 15 mL and the final portion was comprised of the balance of the solution. After completion of the addition, the batch was stirred at a cooling temperature of 0° C. Subsequently, the batch was stirred for 16 h at 20° C.

The greenish-blue dispersion was cooled to 6° C. using stirring in a vessel equipped with a cooling jacket, and treated for 30 min with a 1000 W sonotrode while stirring.

Subsequently, the dispersion was passed though a column filled with beads of a cationic-exchange material (diameter of the column: 3 cm; filling height: 14 cm), and subsequently though a column filled with beads of an anion-exchange material (diameter of the column: 3 cm; filling height: 14 cm). Thereby, the ion conductivity was reduced from 350 μS/cm prior to ion exchange to 150 μS/cm after ion exchange. In order to measure the ion conductivity 1 g of dispersion was mixed with 24 g deionized water.

The resulting dispersion had a solid content of 1% (measured as non-volatile content at 120° C. using a residual moisture analyzer). A spin-coated layer of the dispersion on a glass substrate had a layer thickness of 85 nm and a conductivity of 1 S/cm.

By using different post-treatment methods, inter alia subsequent spin coating of the layer with DMSO, a conductivity of more than 500 S/cm was obtained.

### Example 5

455 g PEDT-PSSH dispersion (Clevios PHCV4) and 104 μL aniline were placed in a 1 L reaction vessel equipped with a cooling jacket and a stirrer. The batch was stirred and cooled for 15 min at a temperature of the cooling liquid of 0° C. A solution of 266 mg ammonium peroxodisulphate in 50 mL water was added to the batch in four portions, each separated by a time interval of 15 min, wherein each of the first three portions had a volume of 10 mL and the final portion was comprised of the balance of the solution. After completion of the addition, the batch was stirred at a cooling temperature of 0° C. Subsequently, the batch was stirred for 16 h at 20° C.

The greenish-blue dispersion was cooled to 6° C. using stirring in a vessel equipped with a cooling jacket and treated for 30 min with a 1000 W sonotrode while stirring.

Subsequently, the dispersion was passed though a column filled with beads of a cationic-exchange material (diameter of the column: 3 cm; filling height: 14 cm), and subsequently though a column filled with beads of an anion-exchange material (diameter of the column: 3 cm; filling height: 14 cm). Thereby, the ion conductivity was reduced from 240 μS/cm prior to ion exchange to 150 μS/cm after ion exchange. In order to measure the ion conductivity 1 g of dispersion was mixed with 24 g deionized water.

The resulting dispersion had a solid content of 1% (measured as non-volatile content at 120° C. using a residual moisture analyzer). A spin-coated layer of the dispersion on a glass substrate had a layer thickness of 62 nm and a conductivity of 0.3 S/cm.

By using different post-treatment methods, inter alfa subsequent spin coating of the layer with DMSO, a conductivity of more than 500 S/cm was obtained.

### Example 6

455 g PEDT-PSSH dispersion (Clevios PHCV4) and 139 μL aniline were placed in a 1 L reaction vessel equipped with a cooling jacket and a stirrer. The batch was stirred and cooled for 15 min at a temperature of the cooling liquid of 0° C. A solution of 355 mg ammonium peroxodisulphate in 50 mL water was added to the batch in four portions, each separated by a time interval of 15 min, wherein each of the first three portions had a volume of 10 mL and the final portion was comprised of the balance of the solution. After completion of the addition, the batch was stirred at a cooling temperature of 0° C. Subsequently, the batch was stirred for 16 h at 20° C.

The greenish-blue dispersion was cooled to 6° C. using stirring in a vessel equipped with a cooling jacket, and treated for 30 min with a 1000 W sonotrode while stirring.

Subsequently, the dispersion was passed though a column filled with beads of a cationic-exchange material (diameter of the column: 3 cm; filling height: 14 cm), and subsequently though a column filled with beads of an anion-exchange material (diameter of the column: 3 cm; filling height: 14 cm). Thereby, the ion conductivity was reduced from 300 μS/cm prior to ion exchange to 150 μS/cm after ion exchange. In order to measure the ion conductivity 1 g of dispersion were mixed with 24 g deionized water.

The resulting dispersion had a solid content of 0.9% (measured as non-volatile content at 120° C. using a residual moisture analyzer). A spin-coated layer of the dispersion on a glass substrate had a layer thickness of 55 nm and a conductivity of 0.4 S/cm.

By using different post-treatment methods, inter alia subsequent spin coating of the layer with DMSO, a conductivity of more than 500 S/cm was obtained.

### Example 7

455 g PEDT-PSSH dispersion (Clevios PHCV4) and 52 μL aniline were placed in a 1 L reaction vessel equipped with a cooling jacket and a stirrer. The batch was stirred and cooled for 15 min at a temperature of the cooling liquid of 0° C. A solution of 133 mg ammonium peroxodisulphate in 50 mL water was added to the batch in four portions, each separated by a time interval of 15 min, wherein each of the first three portions had a volume of 10 mL and the final portion was comprised of the balance of the solution. After completion of the addition, the batch was stirred at a cooling temperature of 0° C. Subsequently, the batch was stirred for 16 h at 20° C.

The greenish-blue dispersion was cooled to 6° C. using stirring in a vessel equipped with a cooling jacket, and treated for 30 min with a 1000 W sonotrode while stirring.

Subsequently, the dispersion was passed though a column filled with beads of a cationic-exchange material (diameter of the column: 3 cm; filling height: 14 cm), and subsequently though a column filled with beads of an anion-exchange material (diameter of the column: 3 cm; filling height: 14 cm). Thereby, the ion conductivity was reduced from 210 μS/cm prior to ion exchange to 150 μS/cm after ion exchange. In order to measure the ion conductivity 1 g of dispersion were mixed with 24 g deionized water.

The resulting dispersion had a solid content of 0.9% (measured as non-volatile content at 120° C. using a residual moisture analyzer). A spin-coated layer of the dispersion on a glass substrate had a layer thickness of 55 nm and a conductivity of 0.2 S/cm.

By using different post-treatment methods, inter alia subsequent spin coating of the layer with DMSO, a conductivity of more than 500 S/cm was obtained.

### Example 8

### Post-Treatment Methods for Spin-Coated ICPs for Increasing the Conductivity

### Spray Coating

500 μL of the ICP dispersion of Example 7 were applied on a freshly cleaned and flamed specimen slide (about 25×25 mm in size). Using a spin coater (Model P6700 of Specialty Coatings Systems Inc.; programme 3: 5 s at 500 rpm, followed by 30 s at 3000 rpm), a spin-coated layer was prepared.

The specimen slide was subsequently dried for 1 min at about 85° C.

Using a spray apparatus filled with solvent, this spin-coated layer was exposed twice to a spray mist. Then, the specimen slide was placed vertically on a paper tissue so that excess liquid was removed. Subsequently, the spin-coated layer was dried on a heater plate at about 85° C. The following solvent compositions and total spraying times were used: DMSO/MeOH (1:1): about 2 min; DMSO: about 4 min; ethylene glycol: about 6 min.

### Dip Coating

500 μL of the ICP dispersion of Example 7 were applied on a freshly cleaned and flamed specimen slide (about 25×25 mm in size). Using a spin coater ((Model P6700 of Specialty Coatings Systems Inc.; programme 3: 5 s AT 500 rpm, followed by 30 s at 3000 rpm), a spin-coated layer was prepared.

The specimen slide was subsequently dried for 1 min at about 85° C.

This spin-coated layer was dipped into the solvent (mixture) while being kept in a horizontal position, and subsequently the lower side of the specimen slide was cleaned with a paper tissue. The specimen slide was then placed for 10 s vertically on a paper tissue to remove excess liquid. Subsequently, the spin-coated layer was dried on a heater plate a about 85° C. The following solvent compositions and dipping times were used: DMSO/MeOH (1:1): about 2 min; DMSO: about 4 min; ethylene glycol: about 6 min.

### Spin Coating

500 μL of the ICP dispersion of Example 7 were applied on a freshly cleaned and flamed specimen slide (about 25×25 mm in size). Using a spin coater ((Model P6700 of Specialty Coatings Systems Inc.; programme 3: 5 s at 500 rpm, followed by 30 s at 3000 rpm), a spin-coated layer was prepared.

The specimen slide was subsequently dried for 1 min at about 85° C.

500 μL of the solvent mixture are applied on the spin-coated layer and subsequently programme 3 of the spin-coater was run (5 s at 500 rpm, then 30 s at 3000 rpm). The specimen slide was subsequently dried at about 85° C. for 1 min. The following solvent compositions were used: DMSO/MeOH (1:1); DMSO; ethylene glycol.

### Example 9

To a dispersion prepared as described in Example 5 were added solutions of methanesulfonic acid so that the weight ratio of the intrinsically conductive polymer (ICP) to acid was from 1:0.2 to 1:2. The weight ratio of the ICP dispersion to diluted methanesulfonic acid was about 1:0.25.

Samples of 0.5 mL of the ICP dispersion were placed on a specimen slide and uniformly dispersed by using a spin coater (5 s at 1500 rpm and 30 s at 3000 rpm). The samples were subsequently dried at about 85° C. for 1 min.

Subsequently, 0.5 mL of concentrated trifluoromethanesulfonic acid were added to the spin-coated layer and dispersed by using a spin coater (5 s at 1500 rpm and 30 s at 3000 rpm). The samples were subsequently dried at about 85° C. for 1 min.

The conductivity was measured using the 4-point probe method (electrode spacing: 2.5 cm). The thickness was determined by using a profilometer. The spin-coated layers had specific conductivities of 1200 to 1700 S/cm.

1-23. (canceled)

24. Process for the preparation of a coating displaying increased conductivity which contains at least one conductive polymer derived from optionally substituted thiophene, in which firstly an aqueous or organic dispersion or solution which contains the at least one conductive polymer is applied to a substrate; thereafter the forming or formed layer is dried; and at least one polar solvent is brought into contact with the formed or forming layer during or after the drying.

25. Process according to claim 24 wherein the coating displaying increased conductivity contains a first conductive polymer and at least one further conductive polymer, wherein the first conductive polymer is derived from optionally substituted thiophene, in which process
a) firstly an aqueous or organic dispersion or solution which contains the conductive polymers is prepared by
i. polymerizing the monomer from which the first conductive polymer is derived in a dispersion or solution of the at least one further polymer, or
ii. polymerizing the monomer from which the at least one further conductive polymer is derived in a dispersion or solution of the first polymer, or
iii. simultaneously polymerizing the monomers from which the conductive polymers are derived in a dispersion or solution,
b) the aqueous or organic dispersion or solution which contains the conductive polymers is then applied to a substrate, and
c) the forming or formed layer is then dried and
d) at least one polar solvent is brought into contact with the formed or forming layer during or after the drying.

26. Process according to claim 24, in which the at least one conductive polymer has repeat units of the following formula 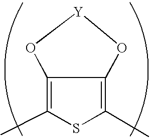
in which Y represents —(CH₂)ₘ—CR¹R²(CH₂)ₙ— or an optionally substituted 1,2-C₃ to C₈ cycloalkylene residue and R¹ and R² independently of each other stand for hydrogen, hydroxymethyl, an optionally substituted C₁ to C₂₀ alkyl residue or an optionally substituted C₆ to C₁₄ aryl residue, and m, n the same or different are an integer from 0 to 3.

27. Process according to claim 25, in which the first monomer and/or the second monomer has the following formula 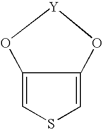
in which Y represents —(CH₂)ₘ—CR¹R²(CH₂)ₙ— or an optionally substituted 1,2-C₃ to C₈ cycloalkylene residue and
R¹ and R² independently of each other stand for hydrogen, hydroxymethyl, an optionally substituted C₁ to C₂₀ alkyl residue or an optionally substituted C₆ to C₁₄ aryl residue, and m, n the same or different are an integer from 0 to 3.

28. Process according to claim 24, in which the coating contains at least one further conductive polymer which is not derived from thiophene or a derivative thereof, or which is derived from thiophene or a derivative thereof and is different from the first polymer.

29. Process according to claim 28, in which the monomer from which the at least one further conductive polymer is derived is not thiophene or a derivative thereof.

30. Process according to claim 31, in which the at least one further conductive polymer is polyaniline.

31. Process according to claim 25, in which the first monomer is EDT and the monomer from which the at least one further conductive polymer is derived is aniline.

32. Process according to claim 25, in which in step a) an aqueous dispersion is prepared which before step b) is converted into a dispersion based on at least one organic dispersant with a water content of less than 1%, relative to the weight of the whole dispersion.

33. Process according to claim 24, in which the at least one polar solvent has a dielectric constant of >25.

34. Process according to claim 24, in which the at least one polar solvent is selected from the group consisting of aliphatic, cycloaliphatic, aromatic, heterocyclic (saturated and unsaturated) and heteroaromatic solvents, sulfonic acid derivatives and also substituted derivatives thereof with a total of 1 to 10 C atoms.

35. Process according to claim 24, in which the at least one polar solvent is selected from the group consisting of DMSO, NMP, diethylene glycol, DMA, DMF and trifluoromethanesulfonic acid.

36. Process according to claim 24, in which the layer also contains at least one non-conductive polymer.

37. Process according to claim 24, in which the layer also contains additives selected from the group consisting of wetting aids, antioxidants and lubricants.

38. Process according to claim 24, in which the at least one polar solvent is brought into contact with the layer out of a gas phase which contains vapour of the solvent, during or after the drying of the layer.

39. Process according to claim 24, in which the at least one polar solvent is brought into contact with the layer, after the drying of the layer, by spin-on deposition, rolling, pressing, dipping, followed by removal of excess quantities by centrifuging, blowing off and/or secondary drying.

40. Process according to claim 24, in which the at least one polar solvent is brought into contact with the layer, before or after drying of the layer, by spray mist and optionally secondary drying.

41. Process for the preparation of an aqueous or organic dispersion or solution which contains a first conductive polymer and at least one further conductive polymer, wherein the first conductive polymer is derived from optionally substituted thiophene, in which
i. the monomer from which the first conductive polymer is derived is polymerized in a dispersion or solution of the at least one further polymer, or
ii. the monomer from which the at least one further conductive polymer is derived is polymerized in a dispersion or solution of the first polymer, or
iii. the monomers from which the conductive polymers are derived are simultaneously polymerized in a dispersion or solution.

42. Process for the preparation of an aqueous or organic dispersion or solution according to claim 41, in which at least one of the conductive polymers has repeat units of the following formula 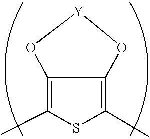
in which Y represents —(CH₂)ₘ—CR¹R²(CH₂)ₙ— or an optionally substituted 1,2-C₃ to C₈ cycloalkylene residue and R¹ and R² independently of each other stand for hydrogen, hydroxymethyl, an optionally substituted C₁ to C₂₀ alkyl residue or an optionally substituted C₆ to C₁₄ aryl residue, and m, n the same or different are an integer from 0 to 3.

43. Process for the preparation of an aqueous or organic dispersion or solution according to claim 41, in which at least one of the conductive polymers has repeat units of the following formula 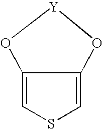
in which Y represents —(CH₂)ₘ—CR¹R²(CH₂)ₙ— or an optionally substituted 1,2-C₃ to C₈ cycloalkylene residue and R¹ and R² independently of each other stand for hydrogen, hydroxymethyl, an optionally substituted C₁ to C₂₀ alkyl residue or an optionally substituted C₆ to C₁₄ aryl residue, and m, n the same or different are an integer from 0 to 3.

44. Process for the preparation of an aqueous or organic dispersion or solution according to claim 41, in which the dispersion or solution contains at least one conductive polymer which is not derived from thiophene or a derivative thereof, or which is derived from thiophene or a derivative thereof and is different from the first polymer.

45. Process for the preparation of an aqueous or organic dispersion or solution according to claim 41, in which the dispersion or solution contains at least one conductive polymer which is not derived from thiophene or a derivative thereof.

46. Process according to claim 45, in which at least one conductive polymer which is not derived from thiophene or a derivative thereof is polyaniline.

47. Process according to claim 41, in which the monomer of the first conductive polymer is EDT and the monomer from which the at least one further conductive polymer is derived is aniline.

48. Process for the preparation of an article selected from the group consisting of transparent substrates, rigid or flexible conductive substrates such as films, in particular films for touch panels, digital paper, organic LEDs (OLEDs), electroluminescence displays, rechargeable batteries, capacitors, supercapacitors, light-emitting diodes, sensors, electrochrome disks, copier drums, cathode ray tubes, antistatic or electromagnetically screening plastic films and moulded parts and photographic materials, in which a coating prepared according to claim 1 is used.
